(19) United States
(12) Patent Application Publication
(10) Pub. No.: US 2014/0101610 A1
(43) Pub. Date: Apr. 10, 2014

(54) APPARATUS, METHOD, COMPTUER PROGRAM AND USER INTERFACE

(71) Applicants: Ning Zhang, Beijing (CN); Mei Dong, Beijing (CN)

(72) Inventors: Ning Zhang, Beijing (CN); Mei Dong, Beijing (CN)

(73) Assignee: Nokia Corporation, Espoo (FI)

(21) Appl. No.: 14/119,658

(22) PCT Filed: May 25, 2011
(86) PCT No.: PCT/CN2011/074635

§ 371 Date: Nov. 22, 2013

(51) Int. Cl. G06F 3/0484; G06F 3/0488; G06F 3/0482

(52) U.S. Cl. CPC G06F 3/04842; G06F 3/0482; G06F 3/0488
USPC 715/810

(57) ABSTRACT

A method, apparatus, computer program and user interface where the method comprises detecting a user input comprising an acceleration of an apparatus; and in response to the detecting of the user input comprising an acceleration, displaying at least one user selectable item on a touch sensitive display of the apparatus.

### TECHNOLOGICAL FIELD

Embodiments of the present invention relate to an apparatus, method, computer program and user interface. In particular, they relate to an apparatus, method, computer program and user interface for providing user selectable items for a user of an apparatus.

### BACKGROUND

Apparatus which provide user selectable items to a user are known. For example, apparatus such as mobile telephones or personal computers may comprise user selectable items as icons on a home screen or as items within a menu structure. A user of the apparatus may be able to select various functions or content of the apparatus by selecting the user selectable items provided.

It may be useful to enable a user to easily and conveniently access the various user selectable items which may be provided.

### BRIEF SUMMARY

According to various, but not necessarily all, embodiments of the invention there is provided a method comprising: detecting a user input comprising an acceleration of an apparatus; and in response to the detecting of the user input comprising an acceleration, displaying at least one user selectable item on a touch sensitive display of the apparatus.

In some embodiments of the invention the at least one user selectable item may be an item of a menu comprising a plurality of user selectable items.

In some embodiments of the invention the menu items may be arranged within a hierarchical menu structure and the user input comprising an acceleration enables a user to navigate to a different level of the hierarchical menu structure.

In some embodiments of the invention the number of user selectable items displayed in response to the user input comprising an acceleration may depend on the characteristics of the user input comprising an acceleration.

In some embodiments of the invention the user selectable items may be added to the display sequentially. The sequence in which the user selectable items are added to the display may be determined by the user of the apparatus.

In some embodiments of the invention the touch sensitive display may be configured to enable a user to select the user selectable item by actuating the portion of the touch sensitive display in which the user selectable item is displayed.

In some embodiments of the invention the position at which the at least one user selectable item is displayed on the touch sensitive display may be determined by the position of at least one of the user's fingers when the user input comprising an acceleration is detected.

In some embodiments of the invention the at least one user selectable item which is displayed on the touch sensitive display may be determined by the position of at least one of the user's fingers when the user input comprising an acceleration is detected.

In some embodiments of the invention the at least one user selectable item might not be displayed on the touch sensitive display until the user input comprising an acceleration has been detected.

In some embodiments of the invention the at least one user selectable item may be displayed as part of a home page.

In some embodiments of the invention the at least one user selectable item may enable access to a different application to content currently displayed on the display.

In some embodiments of the invention the user input comprising an acceleration may comprise shaking of the apparatus.

According to various, but not necessarily all, embodiments of the invention there is provided an apparatus comprising: at least one processor; and at least one memory including computer program code; wherein the at least one memory and the computer program code are configured to, with the at least one processor, enable the apparatus to: detect a user input comprising an acceleration of an apparatus; and in response to the detecting of the user input comprising an acceleration, display at least one user selectable item on a touch sensitive display of the apparatus.

In some embodiments of the invention the apparatus may comprise a touch sensitive display and an accelerometer.

In some embodiments of the invention the at least one user selectable item may be an item of a menu comprising a plurality of user selectable items.

In some embodiments of the invention the menu items may be arranged within a hierarchical menu structure and the user input comprising an acceleration enables a user to navigate to a different level of the hierarchical menu structure.

In some embodiments of the invention the number of user selectable items displayed in response to the user input comprising an acceleration may depend on the characteristics of the user input comprising an acceleration.

In some embodiments of the invention the at least one memory and the computer program code may be configured to add the user selectable items to the display sequentially. The sequence in which the user selectable items are added to the display may be determined by the user of the apparatus.

In some embodiments of the invention the touch sensitive display may be configured to enable a user to select the user selectable item by actuating the portion of the touch sensitive display in which the user selectable item is displayed.

In some embodiments of the invention the position at which the at least one user selectable item is displayed on the touch sensitive display may be determined by the position of at least one of the user's fingers when the user input comprising an acceleration is detected.

In some embodiments of the invention the at least one user selectable item which is displayed on the touch sensitive display may be determined by the position of at least one of the user's fingers when the user input comprising an acceleration is detected.

In some embodiments of the invention the at least one user selectable item might not be displayed on the touch sensitive display until the user input comprising an acceleration has been detected.

In some embodiments of the invention the at least one user selectable item may be displayed as part of a home page.

In some embodiments of the invention the at least one user selectable item may enable access to a different application to content currently displayed on the display.

In some embodiments of the invention the user input comprising an acceleration may comprise the shaking of the apparatus.

According to various, but not necessarily all, embodiments of the invention there is provided a computer program comprising computer program instructions that, when executed by at least one processor, enable an apparatus at least to perform: detecting an user input comprising an acceleration of an apparatus; and in response to the detecting of the user input comprising an acceleration, displaying at least one user selectable item on a touch sensitive display of the apparatus.

In some embodiments of the invention the computer program may comprise program instructions for causing a computer to perform the method of any of the above paragraphs.

In some embodiments of the invention there may be provided a physical entity embodying the computer program as described above.

In some embodiments of the invention there may be provided an electromagnetic carrier signal carrying the computer program as described above.

According to various, but not necessarily all, embodiments of the invention there is provided a user interface comprising: a touch sensitive display: wherein the touch sensitive display is configured to display at least one user selectable item in response to the detection of a user input comprising an acceleration of an apparatus comprising the touch sensitive display.

In some embodiments of the invention the at least one user selectable item is an item of a menu comprising a plurality of user selectable items.

The apparatus may be for wireless communications.

### BRIEF DESCRIPTION

For a better understanding of various examples of embodiments of the present invention reference will now be made by way of example only to the accompanying drawings in which:

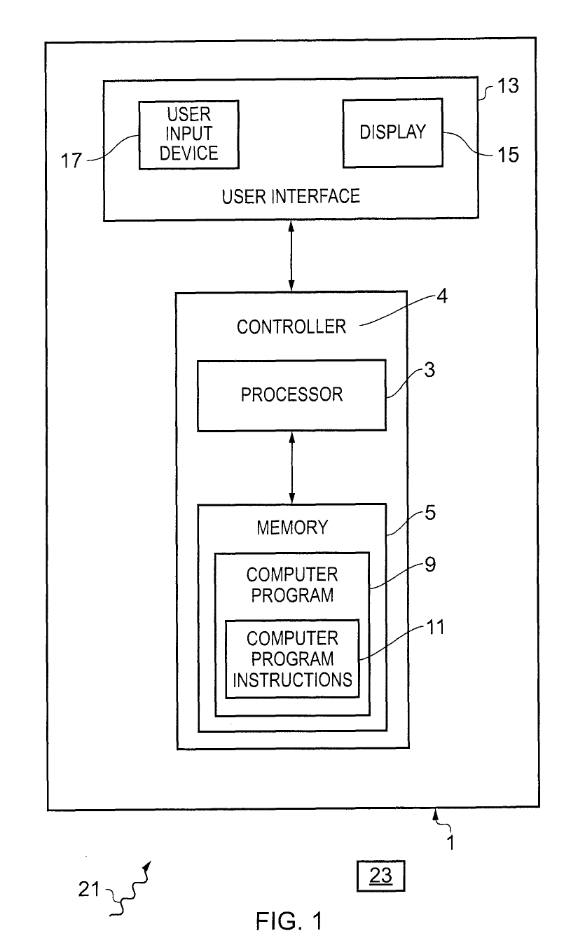

FIG. 1 schematically illustrates an apparatus according to an exemplary embodiment of the invention;

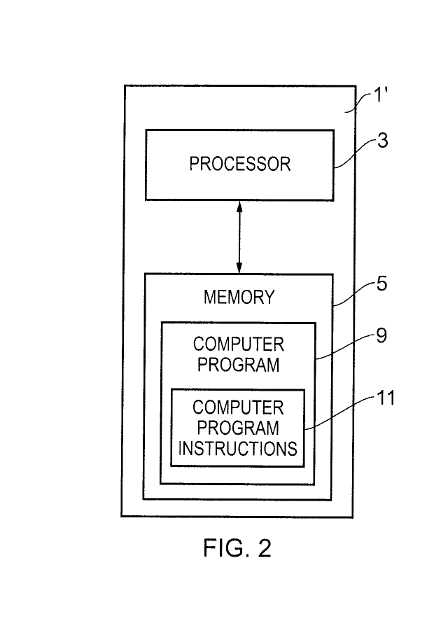

FIG. 2 schematically illustrates an apparatus according to another exemplary embodiment of the invention;

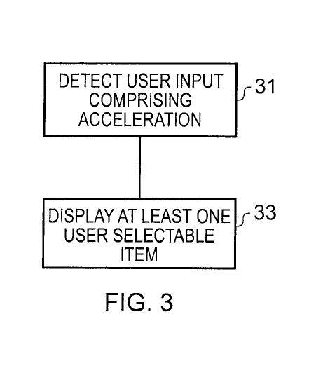

FIG. 3 is a block diagram which schematically illustrates a method according to an exemplary embodiment of the invention;

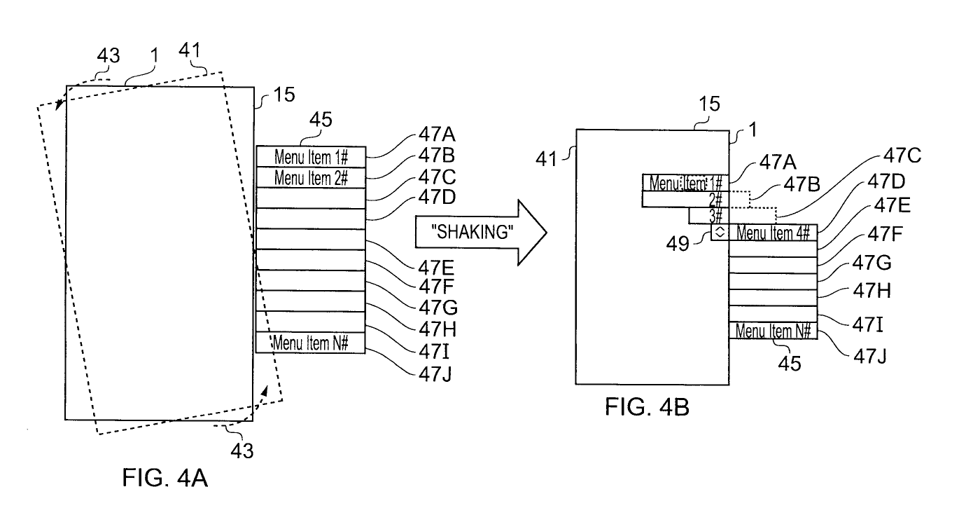

FIGS. 4A and 4B illustrate an exemplary embodiment of the invention; and

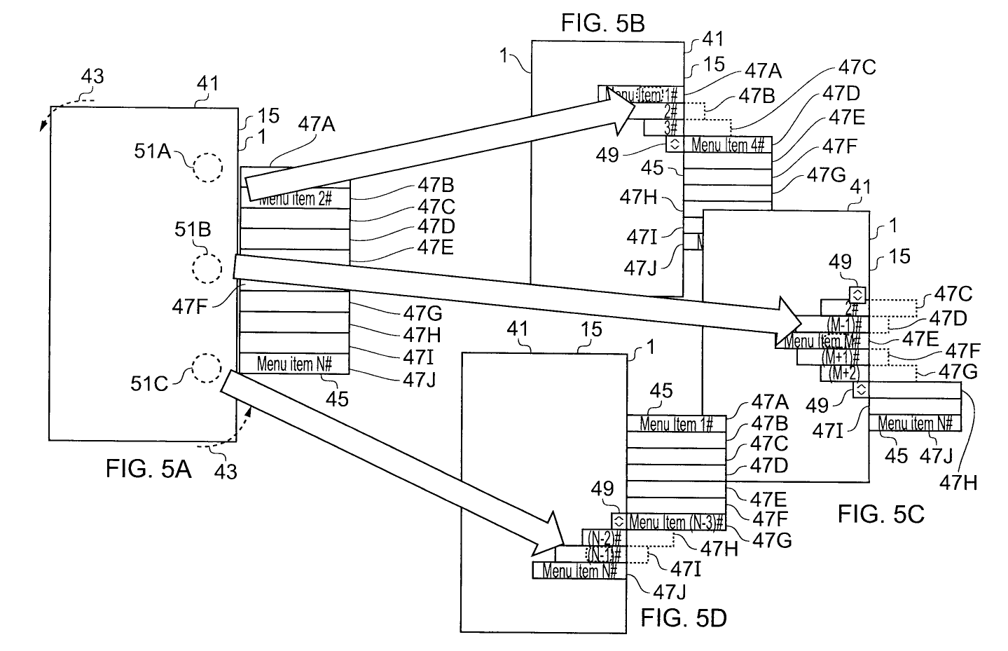

FIGS. 5A to 5D illustrate another exemplary embodiment of the invention

### DETAILED DESCRIPTION

The Figures illustrate an exemplary method comprising A method comprising: detecting 31 a user input comprising an acceleration of an apparatus 1; and in response to the detecting 31 of the user input comprising an acceleration, displaying 33 at least one user selectable item 47 on a touch sensitive display 15 of the apparatus 1.

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a gaming device, a positioning device, a personal digital assistant, a music player or any other apparatus which may be configured to provide one or more user selectable items 47. The apparatus 1 may be a handheld apparatus 1 which can be carried in a user's hand, handbag or jacket pocket for example.

Only features of the apparatus 1 referred to in the following description are illustrated in FIGS. 1 and 2. However, it should be understood that the apparatus 1 may comprise additional features that are not illustrated. For example, in embodiments where the apparatus 1 is a mobile telephone, or any other apparatus configured to enable communication, the apparatus 1 may also comprise one or more transmitters and receivers.

The apparatus 1 illustrated in FIG. 1 comprises: a user interface 13 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and to send and receive messages such as SMS (short message service) messages or MMS (multimedia message service) messages or email messages.

The controller 4 may also be configured to enable the apparatus 1 to detect 31 a user input comprising an acceleration of an apparatus 1; and in response to the detection 31 of the user input comprising an acceleration, display 33 at least one user selectable item 47 on a touch sensitive display 15 of the apparatus 1.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The user input device 17 provides means for enabling a user of the apparatus 1 to input information which may be used to control the apparatus 1. In the exemplary embodiments of the invention the user input device 17 may comprise means for detecting a user input comprising an acceleration of the apparatus 1. For example, the user input device 17 may comprise an accelerometer. A user input comprising an acceleration may be any movement of the apparatus 1 which is controlled by the user of the apparatus 1 which may be detected and used to control the apparatus 1. The movement of the apparatus 1 may be made by the user of the apparatus 1 holding the apparatus 1 in their hand and moving their hand. For example, the user may shake the apparatus 1 or rotate the apparatus 1 in their hand.

The acceleration may be detected by the user input device 17. The acceleration may comprise any change in velocity of the apparatus 1. That is, the acceleration may be any change in the magnitude of the speed of the apparatus 1 which may be an increase or a decrease in speed. The acceleration of the apparatus 1 may also be a change in the direction of the motion of the apparatus 1, for example the apparatus 1 may be moving at a constant speed or substantially constant speed in a circular motion or a substantially circular motion.

The user input device 17 may be configured to detect an acceleration profile of the apparatus 1. An acceleration profile may provide an indication of how the acceleration or velocity of the apparatus 1 changes over time. The user input device 17 may provide an output to the controller 4 which is indicative of the acceleration profile of the apparatus 1. The controller 4 may be configured to recognize particular acceleration profiles and in response to the detection of particular acceleration profile control the apparatus 1 to perform a function corresponding to the recognized acceleration profile. For example, if a user shakes the apparatus 1 by moving the apparatus 1 from side to side, the user input device 17 will detect the user input and provide an indication of the acceleration profile to the controller 4. The acceleration profile for this motion would indicate that the apparatus 1 has increased in speed and decreased in speed whilst moving in a direction towards the left hand side of the user and also that it has increased in speed and decreased in speed whilst moving in a direction towards to the right hand side of the user. The acceleration profile may also indicate that this motion has been repeated and the frequency at which the motion has been repeated. The acceleration profile may also provide an indication of the length of time which this action has been carried out for. The controller may recognize the acceleration profile and then perform an appropriate function corresponding to the recognized profile.

If the user was to move the apparatus 1 in a different manner, for example if they were to move the apparatus 1 in a different motion or for a different length of time or with a different amount of force, then a different acceleration profile may be provided to the controller 4.

In some embodiments of the invention the user interface 13 may also comprise additional user input devices such as a key pad, a joy stick, or any other user input device which enables a user of the apparatus 1 to input information into the apparatus 1 or to control the apparatus 1.

The display 15 may comprise any means which enables information to be displayed to a user of the apparatus 1. The information which is displayed may correspond to information which has been input by the user via the user input device 17, information which is stored in the one or more memories 5 or information which has been received by apparatus 1.

The display 15 may be configured to display graphical user interfaces 41 as illustrated in FIGS. 4A to 4B and 5A to 5D.

The display 15 may comprise a touch sensitive display 15 which is configured to enable a user to control the apparatus 1 or input information into the apparatus 1 via a touch input. The touch sensitive display 15 may comprise any means which is configured to detect touch inputs. A user of the apparatus 1 may make a touch input by actuating the surface of the touch sensitive display 15. The surface of the touch sensitive display 15 may be actuated by a user using their finger or thumb or any other suitable object such as a stylus to physically make contact with the surface. In some embodiments of the invention the user may also be able to actuate the touch sensitive display 15 by bringing their finger, thumb or stylus close to the surface of the touch sensitive display 15. In exemplary embodiments of the invention the touch sensitive display 15 may be a capacitive touch sensitive display or a resistive touch sensitive display or any other suitable type of display.

The output of the touch sensitive display 15 is provided as an input to the controller 4. The output of the touch sensitive display 15 may depend upon the type of actuation of the touch sensitive display 15 and also the location of the area actuated by the user input. The controller 4 may be configured to determine the type of input which has been made and also the location of the user input and enable the appropriate function to be performed in response to the detected input. The type of input may be, for example, a long press input or a double press input.

The at least one memory 5 may be configured to store a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIGS. 3 and 4. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for detecting 31 a user input comprising an acceleration of an apparatus 1; and means for, in response to the detecting 31 of the user input comprising an acceleration, displaying 33 at least one user selectable item 47 on a touch sensitive display 15 of the apparatus 1.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

FIG. 3 illustrates a method according to an exemplary embodiment of the invention.

Embodiments of the invention as illustrated in FIG. 3 provide a method of providing one or more user selectable items 47 for a user of an apparatus 1. The method comprises detecting a user input comprising acceleration of the apparatus 1. The user input comprising acceleration may comprise any movement of the apparatus 1 which is controlled by the user of the apparatus 1. The input may comprise changing the orientation of the apparatus 1 for example changing it from a portrait orientation towards a landscape orientation. The input may also comprise shaking the apparatus 1 up and down, backwards and forwards or from side to side.

When the user begins to make the input comprising the acceleration there may be content displayed on the touch sensitive display 15. The content may relate to a particular application, for example the apparatus 1 may be rendering content such as images or information on the touch sensitive display 15. In such exemplary embodiments the whole of the touch sensitive display 15 could be used to display the content. There may be no section of the touch sensitive display 15 used for displaying user selectable items associated with the content. In other embodiments of the invention when the user input comprising the acceleration is detected 31 the user may be navigating through a hierarchical menu structure so there may be one or more user selectable items displayed on the touch sensitive display 15. The one or more user selectable items may all be items within the same level of the hierarchical menu structure.

In response to the detection 31 of the user input comprising acceleration one or more user selectable items 47 are displayed 33 on the touch sensitive display 15. The touch sensitive display 15 may be configured to enable a user to access functions of the apparatus 1 or content associated with the apparatus 1 by selecting one or more of the displayed user selectable items 47. A user may select a user selectable item 47 by actuating the portion of the touch sensitive display 15 in which the item 47 is displayed.

In some embodiments of the invention there may be a plurality of user selectable items 47 which could be presented to the user. The number of user selectable items 47 which are displayed on the touch sensitive display 15 may be determined by the type of input which has been detected. For example it may be determined by the length of time for which the user has made the user input or by the force or speed with which the input was applied. For example, an additional user selectable item 47 may be added to the display for every given time unit that the user makes the user input for. Alternatively the user input comprising an acceleration may comprise shaking the apparatus from side to side, in which case an additional user selectable item could be added every time the user changes the direction of motion of the apparatus 1. In other embodiments of the invention the number of user selectable items which are displayed on the display may be determined by the magnitude of the force which the user applies to the apparatus 1. For example, the harder the user shakes the apparatus 1 or the faster the user moves the apparatus 1, the more user selectable items which may be provided on the display 15.

The user selectable items 47 may relate to any suitable functions of the apparatus 1. For example, in some embodiments of the invention the apparatus 1 may initially be configured in a home screen. The apparatus 1 may be idle and not performing any specific functions. In such exemplary cases the user selectable items 47 which are displayed 33 in response to the user input comprising an acceleration may relate to the functions or applications which the user accesses most frequently or is likely to access most frequently. For example, where the apparatus 1 is a mobile telephone the user selectable items may relate to the communications functions such as the telephone functions and the various messaging functions which are available. In some embodiments of the invention the user may be able to define which user selectable items 47 they would like to be displayed, either directly by specifically programming those functions as their preferred functions or indirectly through use of the functions.

In some embodiments of the invention the user selectable items 47 which are displayed 33 on the touch sensitive display 15 in response to the input may relate to a function which is currently being performed by the apparatus 1. For example where the apparatus 1 is currently rendering content such as images or information on the touch sensitive display 15 the user selectable items may relate to functions which may be performed on that content. For example it may enable a user to save an image or transmit the image to another apparatus or to exit the application or any other suitable function which would be apparent to a person skilled in the art.

In other embodiments of the invention where the user is navigating through a menu structure the user selectable items 47 which are displayed on the touch sensitive display 15 may relate to a different level of the menu. For example the user selectable items 47 may be items from the previous menu level or from the very top of the menu.

In some embodiments of the invention the position of the user selectable items which are displayed on the touch sensitive display 15 may be determined by the position of the user's finger on the touch sensitive display 15 when they make the user input comprising an acceleration. In some embodiments of the invention the user selectable items may be displayed on the touch sensitive display 15 in a location close to the user's finger. In some embodiments of the invention the user selectable item which is displayed may be determined by the position of the user's finger so that if the user has their finger in a first position a first user selectable item is displayed whereas if the user has their finger in a second, different position a second, different user selectable item may be displayed.

FIGS. 4A and 4B illustrate graphical user interfaces 41 according to an embodiment of the invention.

The apparatus 1 illustrated in FIG. 4A comprises a touch sensitive display 15. A graphical user interface 41 is displayed on the touch sensitive display 15. As described above content or information may be displayed on the touch sensitive display 15 when the user makes the input comprising an acceleration. For example the user may be viewing content such as images on the display or may be navigating through a menu structure so there may be one or more user selectable items already displayed on the display 15.

In FIG. 4A a list 45 of user selectable items 47A to 47J is illustrated adjacent to the apparatus 1. It is to be appreciated that these items are merely illustrated to indicate the plurality of user selectable items 47 that are available to a user and that this list 45 would not be displayed to the user before the user input comprising an acceleration has been detected. In this particular example the user selectable items 47A to 47J are menu items. Each user selectable item 47 may enable access to content, which may be stored in the one or more memories 5, or may enable access to a function of the apparatus 1 or may enable access to another menu level. Each user selectable item 47A to 47J may comprise a label indicative of the function or content associated with each user selectable item 47A to 47J.

In the embodiment illustrated in FIG. 4A the user makes a user input comprising an acceleration by shaking the apparatus 1 in the direction indicated by the arrows 43. The user may shake the apparatus 1 for a period of time by repeating the action. It is to be appreciated that any suitable user input comprising an acceleration may be made.

FIG. 4B illustrates a graphical user interface 41 which may be displayed on the touch sensitive display 15 after the user input comprising an acceleration has been detected.

In this graphical user interface 41 a first user selectable item 47A is displayed on the touch sensitive display 15. The whole of this user selectable item 47A is displayed so that a user may clearly view any labels associated with the item. The user may also be able to select this item 47A as it is completely displayed on the touch sensitive display 15.

A second user selectable item 47B and a third user selectable item 47C are also displayed on the touch sensitive display 15 however these user selectable items 47 are only partially displayed on the display 15. In the exemplary embodiment illustrated in FIG. 4B approximately 80% of the second user selectable item 47B is displayed and approximately half of the third user selectable item 47C is displayed. As only part of these user selectable items 47B and 47C are displayed on the touch sensitive display 15 the user might not be able to select the items user selectable items 47B and 47C until they are completely displayed on the touch sensitive display 15.

In FIG. 4B the second and third user selectable items 47B and 47C are displayed on the touch sensitive display 15 below the first user selectable item 47A. The controller may control the touch sensitive display 15 so that respective user selectable items 47 may appear on the touch sensitive display 15 sequentially. That is, rather than all of the available user selectable items 47 being added on the touch sensitive display 15 at the same time the user selectable items 47 may be added to the touch sensitive display 15 one at a time.

The user selectable items 47 may be added to the touch sensitive display 15 in a predetermined order. In the exemplary embodiment illustrated in FIGS. 4A and 4B the user selectable items 47 are added in the order in which they are listed. The first user selectable item 47A in the list 45 is added to the touch sensitive display 15 first, followed by the second user selectable item 47B and then the third user selectable item 47C and so on. The user of the apparatus 1 may be able to control the apparatus 1 to determine the order of the user selectable items 47 in the list 45. In some embodiments of the invention this may be done directly, for example, the user may select their preferred applications or functions and program the list 45 so that these appear at the top of the list 45. In other embodiments of the invention the user may control the order of the list 45 indirectly. For example, the user selectable items 47 in the list 45 may correspond to content or functions which the user uses most often or has used most recently. The controller 4 may monitor which content or functions the user has accessed and order the user selectable items 47 in the list 45 accordingly.

In the exemplary embodiment in FIG. 4B the user selectable items 47 are added to the touch sensitive display 15 one at a time, each item may be added to the display so that it appears conceptually as though the user selectable items 47 are sliding into place from a position from the side of the apparatus 1.

In FIG. 4B only three of the user selectable items 47 from the list 45 are displayed or partially displayed on the touch sensitive display 15. The remaining items 47D to 47J from the list 45 are not yet displayed on the touch sensitive display 15. In FIG. 4B an item 49 is displayed on the touch sensitive display 15 which provides an indication that there are other user selectable items 47D to 47J which are available but which are not currently displayed on the touch sensitive display 15. In some embodiments of the invention the user may enable the remaining user selectable items 47D to 47J from the list 45 to be displayed on the touch sensitive display 15 by selecting the item 49. The user may also enable the remaining user selectable items 47D to 47J from the first 45 to be displayed on the touch sensitive display 15 by continuing with the user input comprising an acceleration.

Embodiments of the invention as described above provide an easy and convenient way for enabling a user to access user selectable items 47. By performing a simple input such as a shake of the apparatus 1 the user may access any of a plurality of user selectable items 47. The input may be quick, simple and intuitive for a user to make.

As the user selectable items 47 are provided in response to an input comprising an acceleration there is no need to provide any user selectable items on the display until the user input has been made. This enables the whole of the display 15 to be used for rendering content and may be particularly advantageous if the apparatus 1 is one with a limited space available for the display 15.

Embodiments of the invention may also provide a shortcut to enable a user to quickly return to a top level of a menu or a home screen simply by shaking the apparatus. In some embodiments of the invention at least one of the user selectable items 47 may relate to a function or application which is not currently being used by the apparatus 1. This may provide a convenient shortcut for the user to access other functions and applications of the apparatus 1.

FIGS. 5A to 5D illustrate graphical user interfaces 41 according to another embodiment of the invention.

The apparatus 1 illustrated in FIG. 5A is similar to the apparatus 1 illustrated in FIG. 4A. The apparatus 1 comprises a touch sensitive display 15 and a graphical user interface 41 is displayed on the touch sensitive display 15. A list 45 of user selectable items 47A to 47J is illustrated adjacent to the apparatus 1.

As in the previously described embodiments the user makes a user input comprising an acceleration by shaking the apparatus 1 in the direction indicated by the arrows 43. However in the embodiment illustrated in FIGS. 5A to 5D the position in which the user selectable items are added to the display is determined by the positions of the user's finger or thumb on the touch sensitive display 15 when they make the user input comprising the acceleration.

In FIG. 5A three locations on the touch sensitive display 15 are indicated by dashed lines. It is to be appreciated that these lines merely indicate locations where the user may touch the touch sensitive display 15 and need not actually be displayed on the touch sensitive display 15.

If the user positions their finger or thumb in the first location 51A and then makes a user input comprising an acceleration by shaking the apparatus 1 then the user interface 41 illustrated in FIG. 5B is displayed on the touch sensitive display 15. The first location 51A is located near to the top edge of the touch sensitive display 15 and so the user selectable items 47 near the top of the list 45 are displayed on the touch sensitive display 15.

The graphical user interface 41 illustrated in FIG. 5B is similar to the graphical user interface 41 illustrated in FIG. 4B. The user selectable items 47 may be added to the touch sensitive display 15 close to the first location 51A.

Alternatively, if the user positions their finger or thumb in the second location 51B and then makes a user input comprising an acceleration by shaking the apparatus 1 then the user interface 41 illustrated in FIG. 5C is displayed on the touch sensitive display 15. The second location 51B is located near to the middle of the touch sensitive display 15 and so the user selectable items 47 near the middle of the list 45 are displayed on the touch sensitive display 15. The user selectable items 47 may be added to the touch sensitive display 15 close to the second location 51 B.

The graphical user interface 41 illustrated in FIG. 5C differs from the graphical user interface 41 illustrated in FIG. 5B in that the user selectable items 47 are added to the touch sensitive display 15 at a different position. The user selectable items 47 may be added to the touch sensitive display 15 close to the second location 51 B.

Also in the graphical user interface 41 illustrated in FIG. 5C the user selectable items 47 which are added to the display are from the middle of the list 45. In FIG. 5C one user selectable item 47E is completely displayed on the touch sensitive 15. Further user selectable items 47D and 47C are partially displayed on the display above the completely displayed user selectable item 47E and further user selectable items 47F and 47G are partially displayed on the display below the completely displayed user selectable item 47E. This provides an indication to the user that the completely displayed user selectable item 47E is from the middle of the list 45.

The graphical user interface illustrated in FIG. 5C also comprises items which indicate to the user that there are other user selectable items 47 available which are not currently displayed on the touch sensitive display 15. As the currently displayed user selectable item 47E is from the middle of the list 45 two items 49 are provided. This enables a user either to select further items above the completely displayed user selectable item 47E or further items from below the completely displayed user selectable item 47E.

If the user positions their finger or thumb in the third location 51C and then makes a user input comprising an acceleration by shaking the apparatus then the user interface 41 illustrated in FIG. 5D is displayed on the touch sensitive display 15. The third location 51C is located near to bottom edge of the touch sensitive display 15 and so the user selectable items 47 near to the bottom of the list 45 are displayed on the touch sensitive display 15. The user selectable items 47 may be added to the touch sensitive display 15 close to the third location 51C.

In the graphical user interface 41 illustrated in FIG. 5D differs from the graphical user interface 41 illustrated in FIGS. 5B and 5C in that the user selectable items 47 are added to the touch sensitive display 15 at a different position. The user selectable items 47 may be added to the touch sensitive display 15 close to the third location 51C.

As the third location 51C is close to the bottom of the touch sensitive display 15 the user selectable items 47 which are added to the touch sensitive display 15 are from the bottom of the list 45. In FIG. 5D one user selectable item 47J is completely displayed on the touch sensitive display 15. Further user selectable items 47H and 47I are partially displayed on the touch sensitive display 15 above the completely displayed user selectable item 47J. As the completely displayed user selectable item 47J is the last item on the list 45 there are no other user selectable items displayed below the completely displayed user selectable item 47J. This provides an indication to the user that they are viewing items from the bottom of the list 45. An item 49 is provided above the user selectable items to enable a user to view other user selectable items 47 from the list 45.

Embodiments of the invention as described above in relation to FIGS. 5A to 5D provide the further advantages that the user selectable items 47 are displayed on the touch sensitive display 15 close to the position of the user's finger. This may make the apparatus 1 more convenient for a user to use as they do not have to move their finger very much to access the user selectable items 47.

Furthermore the embodiments of the invention as described above in relation to FIGS. 5A to 5D also enable a user to control which of the users selectable items 47 are displayed on the display 15 by touching the appropriate location of the touch sensitive display 15 when they make the user input comprising an acceleration. This may also make the apparatus 1 even easier to use as the user would not need to scroll through all of the available user selectable items 47 to find the one they wanted.

The blocks illustrated in the FIG. 3 may represent steps in a method and/or sections of code in the computer program code 9. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example in the described embodiments of the invention the user selectable items are added to the display in a manner which makes it appear as though they are sliding into position. It is to be appreciated that any other suitable way of adding the user selectable items may be used. For example they could be added as bubbles or petals.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method comprising:
detecting a user input comprising an acceleration of an apparatus; and
in response to the detecting of the user input comprising an acceleration, displaying at least one user selectable item on a touch sensitive display of the apparatus wherein at least one of the user selectable item and the position at which the at least one user selectable item is displayed on the touch sensitive display is determined by the position of at least one of the user's fingers when the user input comprising an acceleration is detected.

2. A method as claimed in claim 1 wherein the at least one user selectable item is an item of a menu comprising a plurality of user selectable items.

3. A method as claimed in claim 2 wherein the menu items are arranged within a hierarchical menu structure and the user input comprising an acceleration enables a user to navigate to a different level of the hierarchical menu structure.

4. A method as claimed in claim 1 wherein the number of user selectable items displayed in response to the user input comprising an acceleration depends on the characteristics of the user input comprising an acceleration.

5. A method as claimed in claim 1 wherein the user selectable items are added to the display sequentially.

6. A method as claimed in claim 5 wherein the sequence in which the user selectable items are added to the display is determined by the user of the apparatus.

7. A method as claimed in claim 1 wherein the touch sensitive display is configured to enable a user to select the user selectable item by actuating the portion of the touch sensitive display in which the user selectable item is displayed.

8. (canceled)

9. (canceled)

10. A method as claimed in claim 1 wherein the at least one user selectable item is not displayed on the touch sensitive display until the user input comprising an acceleration has been detected.

11. A method as claimed in claim 1 wherein the at least one user selectable item is displayed as part of a home page.

12. A method as claimed in claim 1 wherein the at least one user selectable item enables access to a different application to content currently displayed on the display.

13. A method as claimed in claim 1 wherein the user input comprising an acceleration comprises shaking of the apparatus.

14. An apparatus comprising:
at least one processor; and
at least one memory including computer program code;
wherein the at least one memory and the computer program code are configured to, with the at least one processor, enable the apparatus to:
detect a user input comprising an acceleration of an apparatus; and
in response to the detecting of the user input comprising an acceleration, display at least one user selectable item on a touch sensitive display of the apparatus, wherein at least one of the user selectable item and the position at which the at least one user selectable item is displayed on the touch sensitive display is determined by the position of at least one of the user's fingers when the user input comprising an acceleration is detected.

15. An apparatus as claimed in claim 14 wherein the apparatus comprises a touch sensitive display and an accelerometer.

16. An apparatus as claimed in claim 14 wherein the at least one user selectable item is an item of a menu comprising a plurality of user selectable items.

17. An apparatus as claimed in claim 16 wherein the menu items are arranged within a hierarchical menu structure and the user input comprising an acceleration enables a user to navigate to a different level of the hierarchical menu structure.

18. An apparatus as claimed in claim 14 wherein the number of user selectable items displayed in response to the user input comprising an acceleration depends on the characteristics of the user input comprising an acceleration.

19. An apparatus as claimed in claim 14 wherein the at least one memory and the computer program code are configured to add the user selectable items to the display sequentially.

20. An apparatus as claimed in claim 19 wherein the sequence in which the user selectable items are added to the display is determined by the user of the apparatus.

21. An apparatus as claimed in claim 14 wherein the touch sensitive display is configured to enable a user to select the user selectable item by actuating the portion of the touch sensitive display in which the user selectable item is displayed.

22. (canceled)

23. (canceled)

24. (canceled)

25. (canceled)

26. (canceled)

27. (canceled)

28. A tangible physical entity embodying computer program comprising computer program instructions that, when executed by at least one processor, enable an apparatus at least to perform:
detecting an user input comprising an acceleration of an apparatus; and
in response to the detecting of the user input comprising an acceleration, displaying at least one user selectable item on a touch sensitive display of the apparatus wherein at least one of the user selectable item and the position at which the at least one user selectable item is displayed on the touch sensitive display is determined by the position of at least one of the user's fingers when the user input comprising an acceleration is detected.

29. (canceled)

30. (canceled)

31. (canceled)

32. (canceled)

33. (canceled)
